(19) United States
(12) Patent Application Publication
(10) Pub. No.: US 2023/0136609 A1
(43) Pub. Date: May 4, 2023

(54) METHOD AND APPARATUS FOR UNSUPERVISED DOMAIN ADAPTATION

(71) Applicant: SAMSUNG SDS CO., LTD., Seoul (KR)

(72) Inventor: Joon Ho Lee, Seoul (KR)

(21) Appl. No.: 17/973,689

(22) Filed: Oct. 26, 2022

(30) Foreign Application Priority Data
Oct. 28, 2021 (KR) 10-2021-0146096

(51) Int. Cl. G06N 3/08

(52) U.S. Cl. CPC G06N 3/088

(57) ABSTRACT

An unsupervised domain adaptation method for adapting an artificial neural network trained with source data to target data, the unsupervised domain adaptation method includes calculating an average and a standard deviation of a prediction value for a mini-batch of the target data with respect to a first generator, except for a classifier included in the artificial neural network, generating a second generator by training the first generator through a first loss function based on the average and a variance, training a second generator based on a second loss function, based on a difference between a prediction value of the first generator and a prediction value of the second generator for the mini-batch, and calculating a final weight by weighted summing a first weight for minimizing the first loss function and a second weight for minimizing the second loss function.

### CROSS-REFERENCE TO RELATED APPLICATION(S)

This application claims benefit of priority under 35 U.S.C. 119 to Korean Patent Application No. 10-2021-0146096 filed on Oct. 28, 2021 in the Korean Intellectual Property Office, the disclosure of which is incorporated herein by reference in its entirety.

### BACKGROUND

### 1. Field

One or more example embodiments relate to an unsupervised domain adaptation technique.

### 2. Description of Related Art

When an artificial neural network model performing a target task such as classification, object detection, or segmentation is sufficiently trained with data for which a label is prepared, the artificial neural network may perform the target task with a high degree of accuracy.

However, after deploying this model, when data (target data) generated in a usage environment and input to the model has a different distribution from that of data (source data) initially learned, a domain shift phenomenon may occur in which performance of the model is degraded. In this case, a technique for adapting the model to the target data having no label is referred to as unsupervised domain adaptation (UDA).

### SUMMARY

An aspect provides a method and apparatus for unsupervised domain adaptation.

According to an aspect, there is provided an unsupervised domain adaptation method for adapting an artificial neural network trained with source data to target data, the unsupervised domain adaptation method including calculating an average and a standard deviation of a prediction value for a mini-batch of the target data with respect to a first generator, except for a classifier included in the artificial neural network, generating a second generator by training the first generator through a first loss function based on the average and a variance, training a second generator based on a second loss function, based on a difference between a prediction value of the first generator and a prediction value of the second generator for the mini-batch, and calculating a final weight by weighted summing a first weight for minimizing the first loss function and a second weight for minimizing the second loss function.

The calculating of the average and the variance may include iterating, a plurality of times, a process of obtaining the prediction value for the mini-batch of the target data by applying a different random dropout to the first generator each time, and calculating an average and a standard deviation of a plurality of prediction values according to a plurality of times of iterations.

The generating of the second generator may include calculating a prediction uncertainty loss function based on an average of a norm of the standard deviation of the prediction value for the mini-batch of the target data, and the first generator may be trained such that the prediction uncertainty loss function is minimized.

The generating of the second generator may include calculating an entropy loss function that is induced, such that similar pieces of target data are clustered in a feature space, and the first generator may be trained such that the entropy loss function is minimized.

The generating of the second generator may include calculating a diversity loss function that is induced, such that pieces of target data are evenly distributed for each class in a feature space, and the first generator may be trained such that the diversity loss function is maximized.

The first loss function may be generated based on a combination of a prediction uncertainty loss function, an entropy loss function, and a diversity loss function.

The generating of the second generator may include calculating a second loss function based on cross-entropy between the prediction value of the first generator and the prediction value of the second generator for the mini-batch, and the second generator may be trained such that the second loss function is minimized.

The final weight may be calculated by combining the second weight with the first weight, using an exponential moving average.

According to another aspect, there is provided an unsupervised domain adaptation apparatus for adapting an artificial neural network trained with source data to target data, the unsupervised domain adaptation apparatus including a prediction value calculator configured to calculate an average and a standard deviation of a prediction value for a mini-batch of the target data with respect to a first generator, except for a classifier included in the artificial neural network, a generator generation unit configured to generate a second generator by training the first generator through a first loss function based on the average and a variance, a generator trainer configured to train the second generator based on a second loss function, based on a difference between a prediction value of the first generator and a prediction value of the second generator for the mini-batch, and a weight calculator configured to calculate a final weight by weighted summing a first weight for minimizing the first loss function and a second weight for minimizing the second loss function.

The prediction value calculator may be configured to iterate, a plurality of times, a process of obtaining the prediction value for the mini-batch of the target data by applying a different random dropout to the first generator each time, and calculate an average and a standard deviation of a plurality of prediction values according to a plurality of times of iterations.

The generator generation unit may be configured to calculate a prediction uncertainty loss function based on an average of a norm of the standard deviation of the prediction value for the mini-batch of the target data, and the first generator may be trained such that the prediction uncertainty loss function is minimized.

The generator generation unit may be configured to calculate an entropy loss function that is induced, such that similar pieces of target data are clustered in a feature space, and the first generator may be trained such that the entropy loss function is minimized.

The generator generation unit may be configured to calculate a diversity loss function that is induced, such that pieces of target data are evenly distributed for each class in a feature space, and the first generator may be trained such that the diversity loss function is maximized.

The first loss function may be generated based on a combination of a prediction uncertainty loss function, an entropy loss function, and a diversity loss function.

The generator trainer may be configured to calculate a second loss function based on cross-entropy between the prediction value of the first generator and the prediction value of the second generator for the mini-batch, and the second generator may be trained such that the second loss function is minimized.

The final weight may be calculated by combining the second weight with the first weight, using an exponential moving average.

According to example embodiments, it is possible to adapt a trained model to operate properly even when distribution of target data is different from that of source data in a condition in which the source data is not available.

### BRIEF DESCRIPTION OF THE DRAWINGS

The above and other aspects, features, and advantages of the present disclosure will be more clearly understood from the following detailed description, taken in conjunction with the accompanying drawings, in which:

FIG. 1 is a flowchart of an unsupervised domain adaptation method according to an example embodiment;

FIG. 2 is an exemplary diagram illustrating an unsupervised domain adaptation method according to an example embodiment;

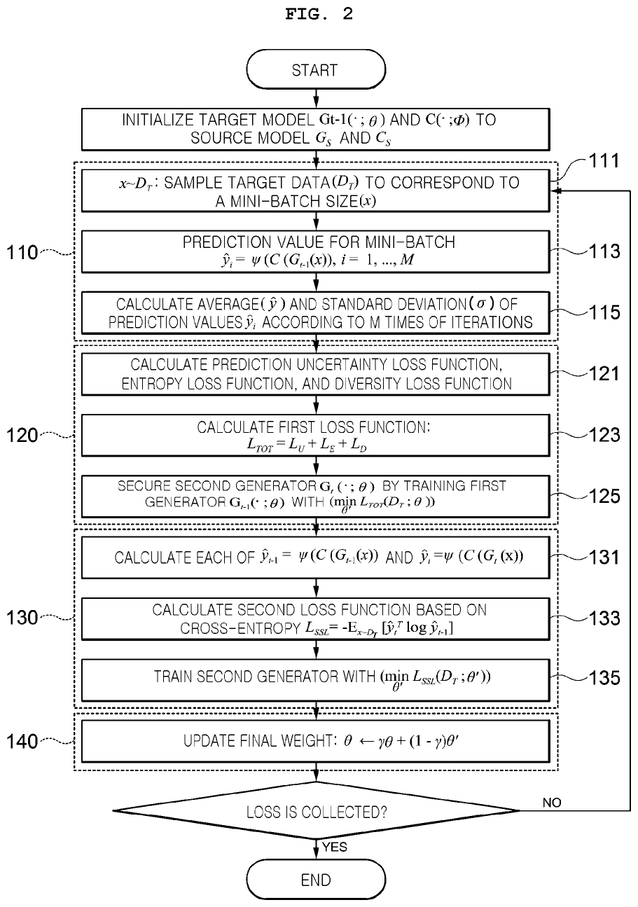

FIG. 3 is a configuration diagram of an unsupervised domain adaptation apparatus according to an example embodiment; and

FIG. 4 is a block diagram illustrating and a computing environment including a computing device according to an example embodiment.

### DETAILED DESCRIPTION

Hereinafter, specific example embodiments of the present disclosure will be described with reference to the accompanying drawings. The following detailed description is provided to aid in a comprehensive understanding of a method, a device and/or a system described in the present specification. However, the detailed description is only for illustrative purpose, and the present disclosure is not limited thereto.

In describing the example embodiments of the present disclosure, when it is determined that a detailed description of known technology related to the present disclosure may unnecessarily obscure the gist of the present disclosure, the detailed description thereof will be omitted. In addition, terms to be described later are terms defined in consideration of functions in the present disclosure, which may vary depending on intention or custom of a user or operator. Therefore, the definition of these terms should be made based on the contents throughout the present specification. The terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

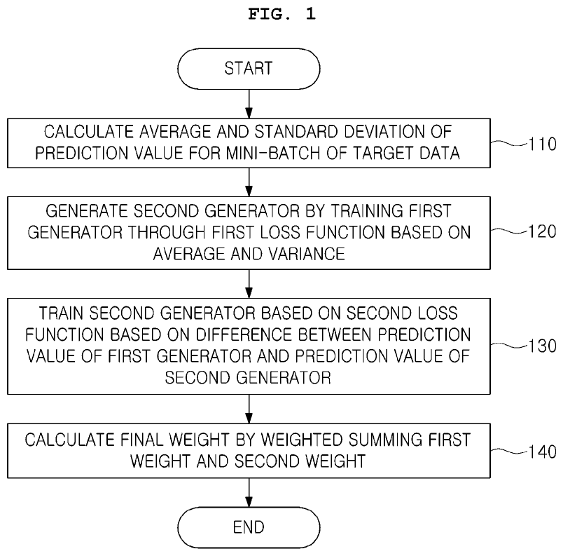

FIG. 1 is a flowchart of an unsupervised domain adaptation method according to an example embodiment.

An unsupervised domain adaptation method for adapting an artificial neural network trained with source data to target data according to an example embodiment may include calculating an average and a standard deviation of a prediction value for a mini-batch of the target data with respect to a first generator, except fora classifier included in the artificial neural network (110).

According to an example, the artificial neural network may include a generator and a classifier. The generator and the classifier may be trained with the source data in an initialization process. For example, the generator and the discriminator initialized by the source data may be denoted by G_{S} and C_{S}, respectively.

According to an example, unsupervised domain adaptation may be performed only by the generator, and the classifier may be maintained in a state initialized by the source data, thereby continuously utilizing a class classification capability of the classifier trained using the source data initially in a condition in which the source data is no longer available. Accordingly, the artificial neural network including G_{S} and C_{S} may be transformed to have a form of G_{T} and C_{S} after performing unsupervised adaptation on the target data.

According to an example, target data [symbol] _{T} may be sampled x to correspond to a mini-batch size (111). Thereafter, the calculating of the average and variance may include iterating, a plurality of times (M times), a process of obtaining the prediction value for the mini-batch of the target data by applying a different random dropout to a first generator each time (113).

According to an example, the first generator may stochastically iterate prediction on target data. For example, unit learning may be iterated a plurality of times using x sampled in D_{T} as a mini-batch. For example, as a method of iterating stochastic inference on x, approximate Bayesian inference may be used. In this case, stochastic inference may inject a dropout into G_{T} and C_{T} during inference, such that inference values may have a stochastic difference.

According to an example embodiment, the calculating of the average and variance may include calculating an average and a standard deviation of a plurality of prediction values according to a plurality of times of iterations (115). For example, when a prediction value is calculated M times with respect to a mini-batch, M prediction value vectors having a dimension of a mini-batch size maybe generated. When an average and a standard deviation of each element included in the M prediction value vectors are calculated, an average vector and a standard deviation vector having a dimension of a mini-batch size may be obtained.

The unsupervised domain adaptation method according to an example embodiment may include generating a second generator by training the first generator through a first loss function based on the average and variance (120).

According to an example, the unsupervised domain adaptation method may include training the first generator using both an entropy loss function minimizing class conditional entropy in an instance-wise manner and a diversity loss function maximizing entropy of a class-wise average score, so as to compensate for a degradation in performance caused by non-use of the source data while training the first generator so as to minimize uncertainty (121).

According to an example embodiment, the generating of the second generator may include calculating a prediction uncertainty loss function based on an average of a norm of a standard deviation of the prediction value for the mini-batch of the target data.

According to an example, the unsupervised domain adaptation method may utilize a predictive variance of a model as prediction uncertainty. For example, in order to quantify the predictive variance, the standard deviation of the prediction value may be obtained from iterative stochastic inference, and then an L1 or L2 norm may be applied in a class manner, or a standard deviation of an argmax score may be applied.

For example, the prediction uncertainty loss function may be defined as follows.

$${ℒ}_{υ} = {𝔼}_{x ∼ {𝒟}_{T}} ‖ {( diag ( \frac{1}{M} {\sum }_{m = 1}^{M} {\hat{y}}_{m} {\hat{y}}_{m}^{T} - ( \frac{1}{M} {\sum }_{m = 1}^{M} {\hat{y}}_{m} ) {( \frac{1}{M} {\sum }_{m = 1}^{M} {\hat{y}}_{m} )}^{T} ) )}^{1 / 2} ‖ \qquad [ Equation 1 ]$$

Here, ŷ=ψ(C(G(x)) is a prediction value (softmax) ψ for a mini-batch x, and M is the number of times of stochastic inferences.

According to an example embodiment, the first generator may be trained such that the prediction uncertainty loss function is minimized.

According to an example embodiment, the generating of the second generator may include calculating the entropy loss function that is induced, such that similar pieces of target data are clustered in a feature space, and the first generator may be trained such that the entropy loss function is minimized.

For example, the entropy loss function may be induced, such that similar ones among pieces of target data having no label are more properly clustered in the feature space. For example, the entropy loss function may be defined as follows.

[symbol]

_{E}=− [symbol] [\hat{y}^{T} log \hat{y}] [Equation 2]

According to an example embodiment, the generating of the second generator may include calculating the diversity loss function that is induced, such that the pieces of target data are evenly distributed for each class in the feature space, and the first generator may be trained such that the diversity loss function is maximized.

For example, the diversity loss function maybe induced, such that the pieces of target data have an even distribution for each class as much as possible in the feature space. For example, the diversity loss function may be defined as follows.

[symbol]

_{D}=( [symbol] [ŷ])^{T} log( [symbol] [\hat{y}]) [Equation 3]

According to an example embodiment, the first loss function may be generated based on a combination of the prediction uncertainty loss function, the entropy loss function, and the diversity loss function. For example, the first loss function may be defined as L_{TOT}=L_{U}+L_{E}+L_{D} (123).

According to an example, the first generator may be trained through the first loss function, and the trained generator may be represented by the second generator (125). For example, the first generator may perform backpropagation so as to minimize a first loss function L_{TOT} with respect to

$${min}_{θ} {ℒ}_{TOT} ( {𝒟}_{T} ; θ ) : G ( \cdot ; θ ) .$$

The unsupervised domain adaptation method according to an example embodiment may include training the second generator based on a second loss function, based on a difference between a prediction value of the first generator and a prediction value of the second generator for the mini-batch (130).

According to an example, the unsupervised domain adaptation method may allow the model to better understand semantic properties of the target data having a different distribution from that of the source data, thereby performing self-supervised learning using a temporal difference for the purpose of further improving classification performance for the target data.

According to an example embodiment, the training of the second generator may include calculating the second loss function based on cross-entropy between the prediction value of the first generator and the prediction value of the second generator for the mini-batch (133).

According to an example, when a generator trained in a t−1^{th} iteration is known as a first generator (Gₜ₋₁) and a generator trained in a t^{th} iteration is known as a second generator (Gₜ), the temporal difference may be used in a manner of minimizing cross-entropy between two predictor vectors so as to maintain cycle consistency between a prediction value ψ(C (Gₜ₋₁ (x)) of the first generator for the knee-batch and a prediction value ψ(C(Gₜ(x)) of the second generator for the mini-batch. For example, the second loss function calculated based on the cross-entropy between the prediction value of the first generator and the prediction value of the second generator may be defined as follows.

[symbol]

_{SSL}=− [symbol] [ψ(C(G_{E}(x))^{T} log ψ(C(Gₜ₋₁(x))] [Equation 4]

According to an example embodiment, the second generator may be trained such that the second loss function is minimized. For example, when a weight trained using a second loss function L_{SSL} from Gₜ is represented by θ′ separately from a first weight θ trained using a first loss function L_{TOT} from Gₜ₋₁, the second generator may be trained through backpropagation so as to minimize the second loss function L_{SSL} with respect to

$${min}_{{θ}^{′}} {ℒ}_{SSL} ( {𝒟}_{T} ; {θ}^{′} ) : {G}^{′} ( \cdot ; {θ}^{′} ) .$$

Here, G′ means that Gₜ is temporarily copied so as to perform independent learning.

The unsupervised domain adaptation method according to an example embodiment may include calculating a final weight by weighted summing a first weight for minimizing the first loss function and a second weight for minimizing the second loss function (140).

According to an example, the final weight may be calculated by combining the weight θ′ of the second generator trained with the second loss function with the weight θ of the second generator trained with the first loss function, using an exponential moving average. For example, the final weight may be represented by θ_{final}=γθ+(1−γ)θ′. Here, γ may have a value of 0.99 to 0.999.

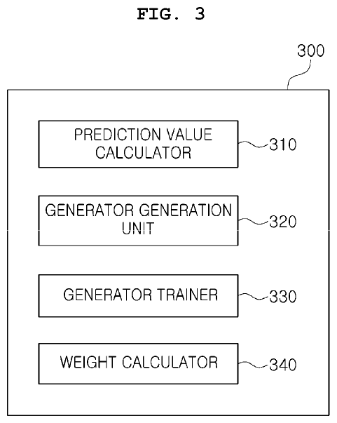

FIG. 3 is a configuration diagram of an unsupervised domain adaptation apparatus according to an example embodiment.

According to an example embodiment, an unsupervised domain adaptation apparatus 300 for adapting an artificial neural network trained with source data to target data may include a prediction value calculator 310 calculating an average and a standard deviation of a prediction value for a mini-batch of the target data with respect to a first generator, except for a classifier included in the artificial neural network

According to an example, the target data [symbol] _{T} may be sampled x to correspond to a mini-batch size. Thereafter, the prediction value calculator 310 may iterate, a plurality of times (M times) , a process of obtaining the prediction value for the mini-batch of the target data by applying a different random dropout to a first generator each time.

According to an example, the first generator may stochastically iterate prediction on the target data. For example, unit learning may be iterated a plurality of times using x sampled in D_{T} as a mini-batch. For example, as a method of iterating stochastic inference on x, approximate Bayesian inference may be used. In this case, stochastic inference may inject a dropout into G_{T} and C_{T} during inference, such that inference values may have a stochastic difference.

According to an example embodiment, the prediction value calculator 310 may calculate an average and a standard deviation of a plurality of prediction values according to a plurality of times of iterations. For example, when a prediction value is calculated M times with respect to a mini-batch, M prediction value vectors having a dimension of a mini-batch size may be generated. When an average and a standard deviation of each element included in the M prediction value vectors are calculated, an average vector and a standard deviation vector having a dimension of a mini-batch size may be obtained.

According to an example embodiment, the unsupervised domain adaptation apparatus 300 may include a generator generation unit 320 generating a second generator by training the first generator through a first loss function based on the average and variance.

According to an example, the generator generation unit 320 may train the first generator using both an entropy loss function minimizing class conditional entropy in an instance-wise manner and a diversity loss function maximizing entropy of a class-wise average score, so as to compensate for a degradation in performance caused by non-use of the source data while training the first generator so as to minimize uncertainty.

According to an example embodiment, the generator generation unit 320 may calculate a prediction uncertainty loss function based on an average of a norm of a standard deviation of the prediction value for the mini-batch of the target data.

According to an example, the unsupervised domain adaptation apparatus may utilize a predictive variance of a model as prediction uncertainty. For example, in order to quantify the predictive variance, the standard deviation of the prediction value may be obtained from iterative stochastic inference, and then an L1 or L2 norm may be applied in a class manner, or a standard deviation of an argmax score may be applied.

According to an example embodiment, the first generator may be trained such that the prediction uncertainty loss function is minimized.

According to an example embodiment, the generator generation unit 320 may calculate the entropy loss function that is induced, such that similar pieces of target data are clustered in a feature space, and the first generator may be trained such that the entropy loss function is minimized.

According to an example embodiment, the generator generation unit 320 may calculate the diversity loss function that is induced, such that pieces of target data are evenly distributed for each class in the feature space, and the first generator may be trained such that the diversity loss function is maximized.

According to an example embodiment, the first loss function may be generated based on a combination of the prediction uncertainty loss function, the entropy loss function, and the diversity loss function.

According to an example, the first generator may be trained through the first loss function, and the trained generator may be represented by the second generator. For example, the first generator may perform backpropagation so as to minimize the first loss function L_{TOT} with respect to

$${min}_{θ} {ℒ}_{TOT} ( {𝒟}_{T} ; θ ) : G ( \cdot ; θ ) .$$

According to an example embodiment, the unsupervised domain adaptation apparatus 300 may include a generator trainer training the second generator based on a second loss function, based on a difference between a prediction value of the first generator and a prediction value of the second generator for the mini-batch.

According to an example, the generator learning unit 330 may allow the model to better understand semantic properties of the target data having a different distribution from that of the source data, thereby performing self-supervised learning using a temporal difference for the purpose of further improving classification performance for the target data.

According to an example embodiment, the generator learner 330 may calculate the second loss function based on cross-entropy between the prediction value of the first generator and the prediction value of the second generator for the mini-batch.

According to an example, when a generator trained in a t−1^{th} iteration is known as a first generator (Gₜ₋₁) and a generator trained in a t^{th} iteration is known as a second generator (Gₜ.), the temporal difference may be used in a manner of minimizing cross-entropy between two predictor vectors so as to maintain cycle consistency between a prediction value ψ (C (Gₜ₋₁ (x)) of the first generator for the knee-batch and a prediction value ψ (C(Gₜ(x)) of the second generator for the mini-batch.

According to an example embodiment, the second generator may be trained such that the second loss function is minimized. For example, when a weight trained using a second loss function L_{SSL} from Gₜ is represented by θ′ separately from a first weight θ trained using a first loss function L_{TOT} from Gₜ₋₁, the second generator may be trained through backpropagation so as to minimize the second loss function L_{SSL}, with respect to

$${min}_{{θ}^{′}} {ℒ}_{SSL} ( {𝒟}_{T} ; {θ}^{′} ) : {G}^{′} ( \cdot ; {θ}^{′} ) .$$

Here, G′ means that Gₜ is temporarily copied so as to perform independent learning.

According to an example embodiment, the unsupervised domain adaptation apparatus 300 may include a weight calculator 340 calculating a final weight by weighted summing a first weight for minimizing the first loss function and a second weight for minimizing the second loss function.

According to an example, the final weight may be calculated by combining the weight θ′ of the second generator trained with the second loss function with the weight θ of the second generator trained with the first loss function, using an exponential moving average. For example, the final weight may be represented by θ_{final}=γθ+(1−γ) θ′. Here, γ may have a value of 0.99 to 0.999.

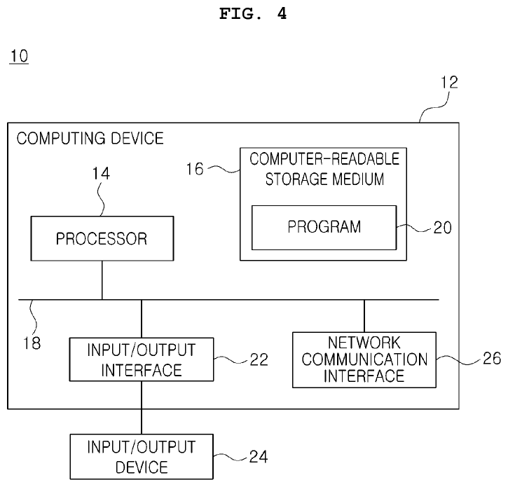

FIG. 4 is a block diagram illustrating and a computing environment including a computing device according to an example embodiment.

In the illustrated example embodiment, each component may have different functions and capabilities in addition to those described below, and additional components may be included in addition to those described below.

An illustrated computing environment 10 may include a computing device 12. In an example embodiment, the computing device 12 may be one or more components included in the unsupervised domain adaptation apparatus 300. The computing device 12 may include at least one processor 14, a computer-readable storage medium 16, and a communication bus 18. The processor 14 may cause the computing device 12 to operate according to the example embodiments described above. For example, the processor 14 may execute one or more programs stored on the computer-readable storage medium 16. The one or more programs may include one or more computer-executable instructions, which, when executed by the processor 14, may be configured to cause the computing device 12 to perform operations according to the example embodiments.

The computer-readable storage medium 16 may be configured to store the computer-executable instruction or program code, program data, and/or other suitable forms of information. A program 20 stored in the computer-readable storage medium 16 may include a set of instructions executable by the processor 14. In an example embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and are capable of storing desired information, or any suitable combination thereof.

The communication bus 18 may interconnect various other components of the computing device 12, including the processor 14 and the computer-readable storage medium 16.

The computing device 12 may also include one or more input/output interfaces 22 providing an interface for one or more input/output devices 24, and one or more network communication interfaces 26. The input/output interface 22 and the network communication interface 26 may be connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touchpad or touchscreen) , a voice or sound input device, input devices such as various types of sensor devices and/or photographing devices, and/or output devices such as a display device, a printer, a speaker, and/or a network card. The exemplary input/output device 24 may be included inside the computing device 12 as a component included in the computing device 12, or may be connected to the computing device 12 as a device distinct from the computing device 12.

While example embodiments have been shown and described above, it will be apparent to those skilled in the art that modifications and variations could be made without departing from the scope of the present disclosure as defined by the appended claims.

What is claimed is:

1. A An unsupervised domain adaptation method for adapting an artificial neural network trained with source data to target data, the unsupervised domain adaptation method comprising:
calculating an average and a standard deviation of a prediction value for a mini-batch of the target data with respect to a first generator, except for a classifier included in the artificial neural network;
generating a second generator by training the first generator through a first loss function, based on the average and the standard deviation;
training a second generator based on a second loss function, based on a difference between the prediction value of the first generator and a prediction value of the second generator for the mini-batch; and
calculating a final weight by weighted-summing a first weight for minimizing the first loss function and a second weight for minimizing the second loss function.

2. The unsupervised domain adaptation method of claim 1, wherein the calculating of the average and the standard deviation includes:
iterating obtaining a plurality of prediction values for the mini-batch of the target data by applying a different random dropout to the first generator each time; and
calculating an average and a standard deviation of the plurality of prediction values.

3. The unsupervised domain adaptation method of claim 1, wherein the generating of the second generator includes calculating a prediction uncertainty loss function based on an average of a norm of the standard deviation of the prediction value for the mini-batch of the target data; and
the first generator is trained such that the prediction uncertainty loss function is minimized.

4. The unsupervised domain adaptation method of claim 1, wherein the generating of the second generator includes calculating an entropy loss function that is induced, such that similar pieces of target data are clustered in a feature space; and
the first generator is trained such that the entropy loss function is minimized.

5. The unsupervised domain adaptation method of claim 1, wherein the generating of the second generator includes calculating a diversity loss function that is induced, such that pieces of target data are evenly distributed for each class in a feature space; and
the first generator is trained such that the diversity loss function is maximized.

6. The unsupervised domain adaptation method of claim 1, wherein the first loss function is generated based on a combination of a prediction uncertainty loss function, an entropy loss function, and a diversity loss function.

7. The unsupervised domain adaptation method of claim 1, wherein the training of the second generator includes calculating a second loss function, based on cross-entropy between the prediction value of the first generator and the prediction value of the second generator for the mini-batch; and
the second generator is trained such that the second loss function is minimized.

8. The unsupervised domain adaptation method of claim 1, wherein the final weight is calculated by combining the second weight with the first weight, using an exponential moving average.

9. An unsupervised domain adaptation apparatus for adapting an artificial neural network trained with source data to target data, the unsupervised domain adaptation apparatus comprising:
a prediction value calculator configured to calculate an average and a standard deviation of a prediction value for a mini-batch of the target data with respect to a first generator, except for a classifier included in the artificial neural network;
a generator generation unit configured to generate a second generator by training the first generator through a first loss function based on the average and the standard deviation;
a generator trainer configured to train the second generator based on a second loss function, based on a difference between a prediction value of the first generator and a prediction value of the second generator for the mini-batch; and
a weight calculator configured to calculate a final weight by weighted summing a first weight for minimizing the first loss function and a second weight for minimizing the second loss function,
wherein at least one of the prediction value calculator, the generator generation unit, the generator trainer and the weight calculator comprises a hardware.

10. The unsupervised domain adaptation apparatus of claim 9, wherein the prediction value calculator is configured to:
iterate a process of obtaining a plurality of prediction values for the mini-batch of the target data by applying a different random dropout to the first generator each time; and
calculate an average and a standard deviation of the plurality of prediction values.

11. The unsupervised domain adaptation apparatus of claim 9, wherein the generator generation unit is configured to calculate a prediction uncertainty loss function based on an average of a norm of the standard deviation of the prediction value for the mini-batch of the target data; and
the first generator is trained such that the prediction uncertainty loss function is minimized.

12. The unsupervised domain adaptation apparatus of claim 9, wherein the generator generation unit is configured to calculate an entropy loss function that is induced, such that similar pieces of target data are clustered in a feature space; and
the first generator is trained such that the entropy loss function is minimized.

13. The unsupervised domain adaptation apparatus of claim 9, wherein the generator generation unit is configured to calculate a diversity loss function that is induced, such that pieces of target data are evenly distributed for each class in a feature space; and
the first generator is trained such that the diversity loss function is maximized.

14. The unsupervised domain adaptation apparatus of claim 9, wherein the first loss function is generated based on a combination of a prediction uncertainty loss function, an entropy loss function, and a diversity loss function.

15. The unsupervised domain adaptation apparatus of claim 9, wherein the generator trainer is configured to calculate a second loss function based on cross-entropy between the prediction value of the first generator and the prediction value of the second generator for the mini-batch; and
the second generator is trained such that the second loss function is minimized.

16. The unsupervised domain adaptation apparatus of claim 9, wherein the final weight is calculated by combining the second weight with the first weight, using an exponential moving average.
